(19) United States
(12) Patent Application Publication
(10) Pub. No.: US 2024/0397493 A1
(43) Pub. Date: Nov. 28, 2024

(54) DIFFERENTIATED ADMISSION CONTROL FOR SINGULAR FLOW WITH BIFURCATED PRIORITIES

(71) Applicant: Microsoft Technology Licensing, LLC, Redmond, WA (US)

(72) Inventors: Vijay RAJESH KUMAR, Bothell, WA (US); Luis IRUN-BRIZ, Sammamish, WA (US)

(21) Appl. No.: 18/322,556

(22) Filed: May 23, 2023

(51) Int. Cl. H04W 72/0453

(52) U.S. Cl. CPC H04W 72/0453

(57) ABSTRACT

Solutions are disclosed that enable differentiated admission control for singular flows with bifurcated priorities in a wide area network (WAN). Examples include receiving a bandwidth request for each of a plurality of data flows, each request indicating a primary bandwidth request portion and a deferrable bandwidth request portion; aggregating the bandwidth requests for the plurality of data flows into an aggregate bandwidth request, the aggregate bandwidth request indicating a primary aggregate bandwidth request portion and a deferrable aggregate bandwidth request portion; determining, based on at least the aggregate bandwidth request, a granted primary aggregate bandwidth and a granted deferrable aggregate bandwidth; and based on at least the granted primary aggregate bandwidth and the granted deferrable aggregate bandwidth, allocating, for each bandwidth request for the plurality of data flows, a granted primary bandwidth and a granted deferrable bandwidth.

### BACKGROUND

In large wide area networks (WANs), data flows between source and destination regions may use pre-defined paths often referred to as tunnels. The set of tunnels has a known topology and capacity, permitting intelligent traffic management. One traffic management tool is data brokering, which is used to limit and prioritize data traffic such that higher priority traffic reliably traverses the network with minimal delays, while delays due to network congestion are borne by lower priority traffic. Data brokering involves throttling when requests for traffic bandwidth, presented to an admission control function that grants bandwidth for brokered data flows, exceed network capacity.

### SUMMARY

The disclosed examples are described in detail below with reference to the accompanying drawing figures listed below. The following summary is provided to illustrate some examples disclosed herein.

Example solutions for differentiated admission control for singular flow with bifurcated priorities include: receiving a bandwidth request for each of a plurality of data flows of a wide area network (WAN), each bandwidth request indicating a primary bandwidth request portion and a deferrable bandwidth request portion; aggregating the bandwidth requests for the plurality of data flows into an aggregate bandwidth request, the aggregate bandwidth request indicating a primary aggregate bandwidth request portion and a deferrable aggregate bandwidth request portion; determining, based on at least the aggregate bandwidth request, a granted primary aggregate bandwidth and a granted deferrable aggregate bandwidth; and based on at least the granted primary aggregate bandwidth and the granted deferrable aggregate bandwidth, allocating, for each bandwidth request for the plurality of data flows, a granted primary bandwidth and a granted deferrable bandwidth.

### BRIEF DESCRIPTION OF THE DRAWINGS

The disclosed examples are described in detail below with reference to the accompanying drawing figures listed below:

FIG. 1 illustrates an example wide area network (WAN) architecture that advantageously provides differentiated admission control for a singular flow with bifurcated priorities;

FIG. 2 illustrates further detail for the example architecture of FIG. 1;

FIG. 3 also illustrates further detail for the example architecture of FIG. 1;

FIG. 4 illustrates an example code passage associated with a bandwidth request, such as may be used in the example architecture of FIG. 1;

FIG. 5 illustrates an example code passage associated with a response to a bandwidth request, such as may be used in the example architecture of FIG. 1;

FIG. 6 illustrates example variations in the formatting of bifurcated priority bandwidth request, such as may be used in the example architecture of FIG. 1;

FIGS. 7 and 8 show flowcharts illustrating exemplary operations that may be performed when using example architectures, such as the architecture of FIG. 1; and

FIG. 9 shows a block diagram of an example computing device suitable for implementing some of the various examples disclosed herein.

Corresponding reference characters indicate corresponding parts throughout the drawings.

### DETAILED DESCRIPTION

A wide area network (WAN) may provide for data flows between different regions, such as geographically-dispersed data centers, carrying data traffic among sets of servers. An example is an Exchange Online (EXO), a cloud based messaging platform that delivers email, calendar, contacts, and tasks, also uses geo-replication to provide for disaster recovery. EXO replication mirrors data across geographically distributed server clusters in different data centers. Both customer-facing workloads, such as email and other user-interactive data, that is subject to a service level objectives (SLO), and background workloads, such as data replication traffic, traverse the same WAN.

Whereas traffic delays for customer-facing workloads are noticeable and potentially frustrating for users, some background workloads may be deferred without negatively impacting application SLOs, when there is a temporary loss in network capacity. These background workloads may be referred to as deferrable workloads, while the more time-critical customer-facing may be referred to as primary workloads. However, for WANs having a limited set of priority levels, such as three tiers (e.g., Pri-0 as highest, Pri-1 as next, and Pri-2 as lowest), both primary workloads and deferrable workloads may both be assigned the same Pri-2 priority level in a single data flow.

The inability of an application, EXO geo-replication, to separate its traffic into primary versus deferrable means that the flow cannot be explicitly partitioned to enable differentiated behavior during data brokering. Unfortunately then, primary workloads may be throttled due to a large amount of deferrable workload traffic that is presented to the admission control function of the data brokering infrastructure. In some examples, deferrable data traffic may also be identified as mean time to repair (MTTR) tolerant traffic. Another example is that a news feed and a search engine index may both be given Pri-2 priority, but delays in a news feed is more noticeable to users than delays in a search engine index replication.

Aspects of the disclosure resolve this by introducing differentiated admission control for a single data flow with bifurcated priorities, that enables applications to provide an input as to how much of their data can be deferred. Examples include receiving a bandwidth request for each of a plurality of data flows, each request indicating a primary bandwidth request portion and a deferrable bandwidth request portion; aggregating the bandwidth requests for the plurality of data flows into an aggregate bandwidth request, the aggregate bandwidth request indicating a primary aggregate bandwidth request portion and a deferrable aggregate bandwidth request portion; determining, based on at least the aggregate bandwidth request, a granted primary aggregate bandwidth and a granted deferrable aggregate bandwidth; and based on at least the granted primary aggregate bandwidth and the granted deferrable aggregate bandwidth, allocating, for each bandwidth request for the plurality of data flows, a granted primary bandwidth and a granted deferrable bandwidth.

The example solutions described herein improve the responsiveness of WANs by improving the prioritization of data traffic, such that customer-facing workloads and other data traffic subject to SLOs are prioritized over deferrable workloads, even when both classes of workloads are mixed within the same data flow. This is accomplished by, at least, an aggregate bandwidth request indicating a primary aggregate bandwidth request portion and a deferrable aggregate bandwidth request portion. One practical aspect of these advantages is that a WAN of a given size may carry more time-critical data traffic, during periods of partial WAN degradation and/or the number of routing nodes within a WAN may be reduced in order to maintain a given level of support for time-critical data traffic.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

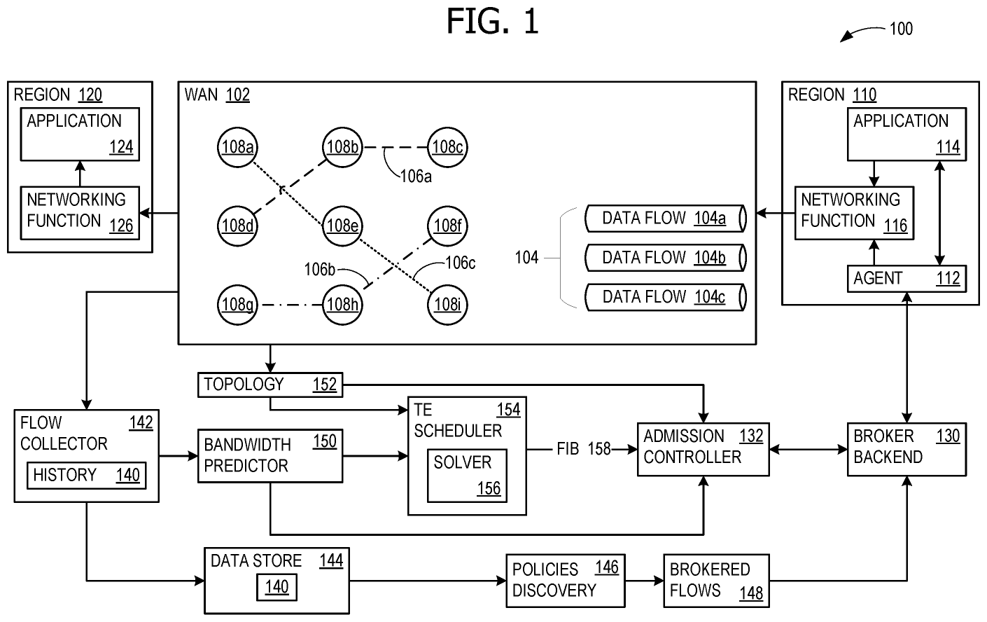

FIG. 1 illustrates an example architecture 100 that advantageously provides differentiated admission control for singular flow with bifurcated priorities. In architecture 100, a WAN 102 carries data from a region 110 to a region 120 as a plurality of data flows 104, using paths defined as tunnels 106a-106c comprising routers 108a-108i. Specifically, data moves from an application 114 through a networking function 116, across WAN 102 to a networking function 126, and into another application 124. An example may be EXO replication represented by applications 114 and 124, in which data from application 114 is being replicated at application 124. Regions 110 and 120 may represent different data centers, and there may be thousands of data flows between different regions, in some examples.

Within WAN 102, a traffic engineering controller (not shown) programs agents at routers 108a-108i to create tunnels. A set of exemplary tunnels is shown, although other examples may involve a larger number of routers and a more complex topology. As illustrated, tunnel 106a passes from router 108c through router 108b to router 108d, tunnel 106b passes from router 108f through router 108h to router 108g, and tunnel 106c passes from router 108i through router 108e to router 108a.

Plurality of data flows 104 includes a data flow 104a, a data flow 104b, and a data flow 104c, although some examples may use a larger number of data flows. Each of data flows 104a-104c may use any of tunnels 106a-106c. In this described example, at least data flow 104a is brokered, although in some examples, not all data flows within WAN 102 are brokered. A data flow is uniquely defined by network N-tuple, such as a 5-tuple, and includes the data that passes through WAN 102 using that N-tuple.

A 5-tuple, used to define a data flow such as data flow 104a, uses <source address, source port, destination address, destination port, protocol>. An example is the first five terms of: <EXO_BE_machine, *, EXO_BE_machine, 12345, TCP, Pri-2, exo_replication, 8>. In this example, the source is an EXO server, any port, and the destination is port 12345 of another EXO server, and the protocol is transmission control protocol (TCP). This data flow example is priority 2 (the lowest priority tier of a priority scheme using Pri-0, Pri-1, and Pri-2 designations). In a 3-tier priority scheme, Pri-0 data flows take the shortest paths, while Pri-1 and Pri-2 (2^{nd} and 3^{rd} tier) are scavenger flows and may take longer paths. This data flow is given an identifier name of “exo_replication” and has a differentiated services code point (DSCP) value of 8, which is used for packet classification.

paths, while Pri-1 and Pri-2 (2^{nd} and 3^{rd} tier) are scavenger flows and may take longer paths.

At least some of routers 108a-108i send traffic flow information to a set of flow collectors, represented by a flow collector 142, which aggregates and annotates traffic reports to compile them into a history 140 of data traffic within WAN 102. History 140 includes the history of plurality of data flows 104. History 140 is sent to a high volume data store 144. On some schedule (e.g., on the order of an hour) history 140 is mined by a policies discovery node 146 for a set of policies to identify a set of brokered flows 148. Brokered flows 148 includes data flow 104a and other data flows that are to be brokered within WAN 102. Brokered flows 148 is provided to a broker backend 130 and other broker backends providing data flow brokering for WAN 102.

A bandwidth predictor 150 uses history 140 (or some version of it from flow collector 142) to generate forward-looking predictions of bandwidth demand within WAN 102, for at least some subset (which may be most or all) of data traffic between applications of the various regions (e.g., regions 110 and 120) transmitting data through WAN 102. This furnishes bandwidth demand predictions on some schedule (e.g., on the order of a minute), which is provided to a traffic engineering scheduler 154 and an admission controller 132.

Additionally, a network topology graph 152 is generated using information regarding tunnels 106a-106c, such as tunnel liveness and capacity, providing the current state of WAN 102. Network topology graph 152 is also provided to traffic engineering scheduler 154 and admission controller 132. Traffic engineering scheduler 154 has a solver 156 that generates a forwarding information base (FIB) table 158 that is similar to a routing table, and is used by the traffic engineering controller to plan the next generation of tunnels within WAN 102. Traffic engineering scheduler 154 sends FIB table 158 to admission controller 132.

Admission controller 132 provides data flow brokering for WAN 102 along with broker backend 130 and a broker agent 112. In an example configuration, WAN 102 has tens of thousands of data flows, thousands of broker agents 112, tens of broker backends 130, and a single admission controller 132 per realm (e.g., North America, Europe, etc.). The broker agents, including broker agent 112, monitor data flows and present bandwidth requests for the brokered data flows, to a broker backend, such as broker backend 130. The broker backends (including broker backend 130) aggregate the bandwidth requests and forward the aggregated bandwidth requests to admission controller 132.

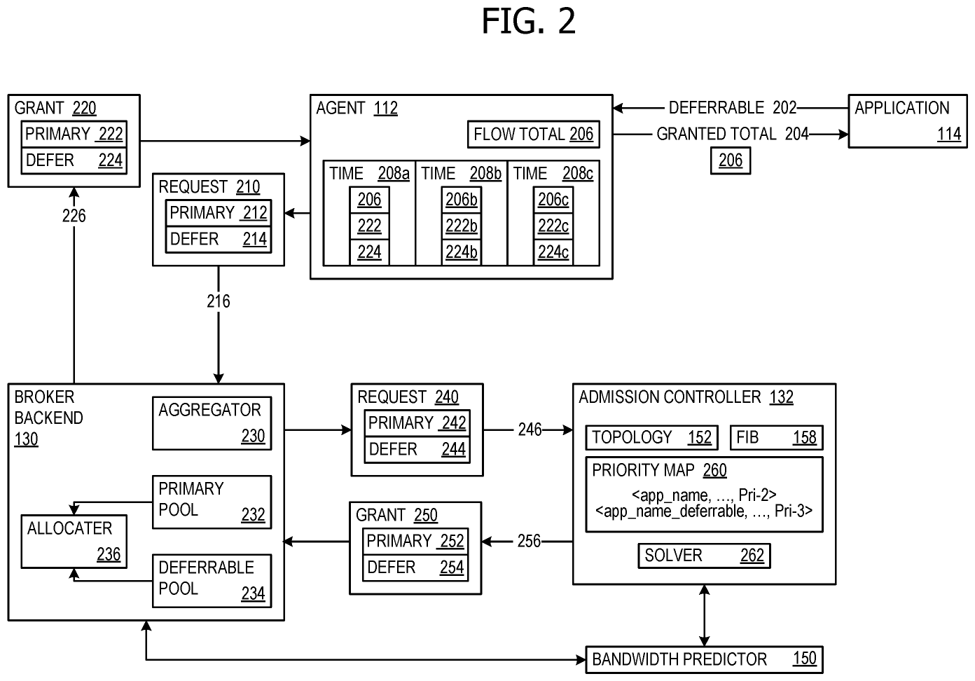

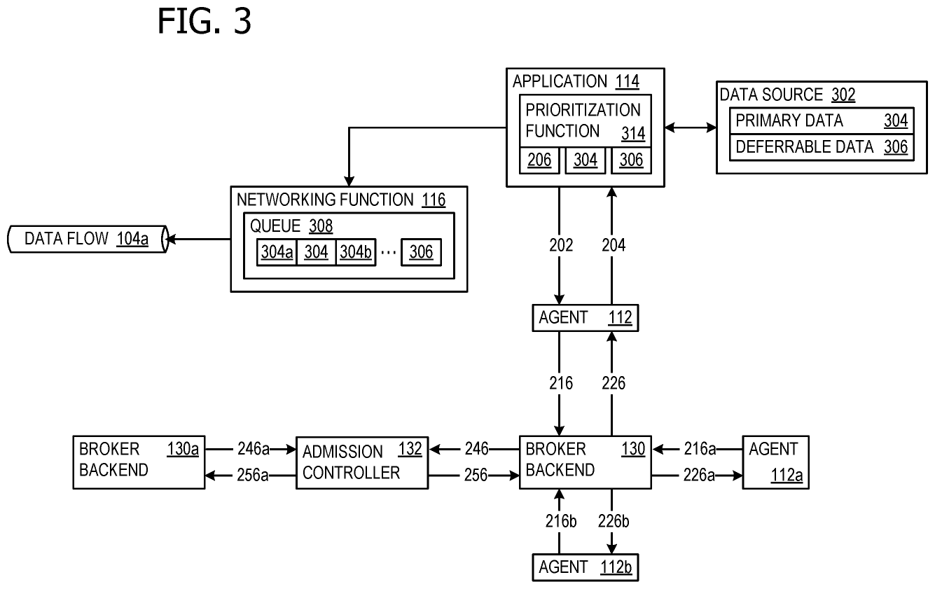

Admission controller 132 makes per-flow bandwidth allocation decisions as an optimization problem for WAN 102, and returns bandwidth grant decisions to broker backends. Admission controller 132 is enabled to perform this role because it has FIB table 158, network topology graph 152, and input from bandwidth predictor 150 (e.g., at least some of history 140 of plurality of data flows 104). The broker backends maintain bandwidth pools, which are segmented into time slots, and allocate bandwidth for the various data flows from the bandwidth pools. The broker backends return bandwidth grants to the broker agents. The granted bandwidth is used to throttle data, as necessary, going into WAN 102. For example, a bandwidth request for a data flow may be a total of 250 megabits per second (Mbps), but the grant is 150 Mbps. Representative communication among admission controller 132, broker backend 130, and broker agent 112 is shown in further detail in FIGS. 2 and 3.

In FIG. 2, application 114 sends an indication 202 of deferrable traffic to broker agent 112 for data flow 104a. Broker agent 112 assembles a bandwidth request 210, which includes a primary bandwidth request portion 212 and a deferrable bandwidth request portion 214, as a message 216 to broker backend 130. Broker backend 130 aggregates bandwidth request 210 with other bandwidth requests from broker agent 112 and/or other broker agents (see FIG. 3), using an aggregator 230.

Broker backend 130 sends an aggregate bandwidth request 240, which includes a primary aggregate bandwidth request portion 242 and a deferrable aggregate bandwidth request portion 244 to admission controller 132 as a message 246. Primary aggregate bandwidth request portion 242 includes primary bandwidth request portion 212, and deferrable aggregate bandwidth request portion 244 includes deferrable bandwidth request portion 214.

Admission controller 132 uses network topology graph 152, FIB table 158, and input from bandwidth predictor 150 to generate a priority map 260, which tracks bandwidth requests from application 114 using “app_name”, which is the identification of application 114, to track bandwidth requested as primary bandwidth request portion 212 and “app_name_deferrable” (i.e., the identification of application 114 appended with “_deferrable) to track bandwidth requested as deferrable bandwidth request portion 214. As indicated, primary bandwidth request portion 212 retains Pri-2, whereas deferrable bandwidth request portion 214 is given Pri-3, which is a priority tier lower than Pri-2. However, data flow 104a is a singular Pri-2 data flow. The lower priority will be handled within the Pri-2 data flow scheme by application 114 prioritizing data traffic based on the criteria it used to produce indication 202 of deferrable traffic, when it receives the granted bandwidth.

When admission controller 132 performs admission control, it runs a solver 262 with two rows of input split across different priority tiers, solver 262 will process all Pri-2 demands from the various broker agents before attempting to admit Pri-3. This will thereby enable deferrable demands to be admitted only if there is capacity remaining after satisfying all demands at higher priorities (e.g., Pri-0, Pri-1, and Pri-2). This ensures that deferrable data traffic for data flow 104a will be reduced prior to another data flow's primary data traffic being denied entry into WAN 102.

Admission controller 132 returns an indication 250 of a granted primary aggregate bandwidth 252 and a granted deferrable aggregate bandwidth 254 to broker backend 130 as a message 256. Broker backend 130 adds granted primary aggregate bandwidth 252 to a primary bandwidth pool 232 and adds granted deferrable aggregate bandwidth 254 to a deferrable bandwidth pool 234. Broker backend 130 allocates a granted primary bandwidth 222 and a granted deferrable bandwidth 224 to data flow 104a using an allocator 236. Allocator also allocates primary and deferred bandwidth grants to other data flows from primary bandwidth pool 232 and deferrable bandwidth pool 234, respectively.

Broker backend 130 sends an indication 220 of granted primary bandwidth 222 and granted deferrable bandwidth 224 to broker agent 112 as a message 226. Broker agent 112 determines a granted total bandwidth 206 for data flow 104a as the sum of granted primary bandwidth 222 and granted deferrable bandwidth 224. Broker agent 112 also maintains a set of time slots for the time periods for which a bandwidth grant is valid. For example, as illustrated, granted total bandwidth 206, granted primary bandwidth 222, and granted deferrable bandwidth 224 are assigned to a time period 208a. Another granted total bandwidth 206b, another granted primary bandwidth 222b, and another granted deferrable bandwidth 224b are assigned to a time period 208b; and another granted total bandwidth 206c, another granted primary bandwidth 222c, and another granted deferrable bandwidth 224c are assigned to a time period 208c. This representation is notional, to illustrate that bandwidth request and grants/allocations are for specific time periods.

Broker agent 112 sends an indication 204 of granted total bandwidth 206 for data flow 104a to application 114. Because application 114 has prioritization logic, which is used to determine indication 202 of deferrable traffic, if granted total bandwidth 206 exceeds the bandwidth needed for the primary data traffic, application 114 will send the primary data traffic first, and push back on the deferrable traffic as necessary to avoid exceeding granted total bandwidth 206.

FIG. 3 illustrates application 114 receiving data from a data source 302. The data includes primary data 304 and deferrable data 306. Indication 202 of deferrable traffic of FIG. 2 is driven by the amount of deferrable data 306. Primary data 304 and deferrable data 306 are both destined for data flow 104a, with primary data 304 driving the amount of primary bandwidth request portion 212 and deferrable data 306 driving the amount of deferrable bandwidth request portion 214.

After the bandwidth requests and grants described above, primary data 304 is sent along data flow 104a based on granted primary bandwidth 222 and deferrable data 306 is sent along data flow 104a based on granted deferrable bandwidth 224. Application 114 receives primary data 304 and deferrable data 306 and is alerted to granted total bandwidth 206 for data flow 104a, and uses its prioritization function 314 to prioritize primary data 304 over deferrable data 306. If granted total bandwidth 206 at least meets primary bandwidth request portion 212, all of primary data 304 is sent along data flow 104a.

The amount by which granted total bandwidth 206 exceeds primary bandwidth request portion 212 is granted deferrable bandwidth 224, and that amount of deferrable data 306 is transmitted in the same time period. Any amount of deferrable data 306 exceeding granted deferrable bandwidth 224 is deferred to a later time period. Application 114 pushes back on data source 302 in some examples, and the deferred portion of deferrable data 306 waits in application 114 and/or data source 302.

Application 114 sends the permitted amount of data to networking function 116. Networking function 116 performs throttling, as needed, to granted total bandwidth 206, and maintains a data queue 308 for data to be sent through data flow 104a. As illustrated, data queue 308 has primary data 304a from a prior time period, primary data 304 for the current time period (e.g., time period 208a of FIG. 2), and primary data 304b or a subsequent time period in the future (e.g., time period 208b). Also shown is deferrable data 306 delayed in data queue 308.

FIG. 3 also shows indications 202 and 204 between application 114 and broker agent 112 and messages 216 and 226 between broker agent 112 and broker backend 130. Further, to illustrate the aggregation and allocation functions of broker backend 130, additional messages 216a-226b are shown between broker backend 130 and additional broker agents. A broker agent 112a sends message 216a to broker backend 130 requesting bandwidth for another data flow and receives a bandwidth grant as message 226a. Similarly, a broker agent 112b sends message 216b to broker backend 130 requesting bandwidth for yet another data flow and receives a bandwidth grant as message 226b.

Admission controller exchanges messages 246 and 256 with broker backend 130, as described above for FIG. 2, and also exchanges similar messages 246a and 256a with another broker backend 130a. Specifically, message 246a is an aggregated request for bandwidth and message 256a is an aggregated grant of bandwidth.

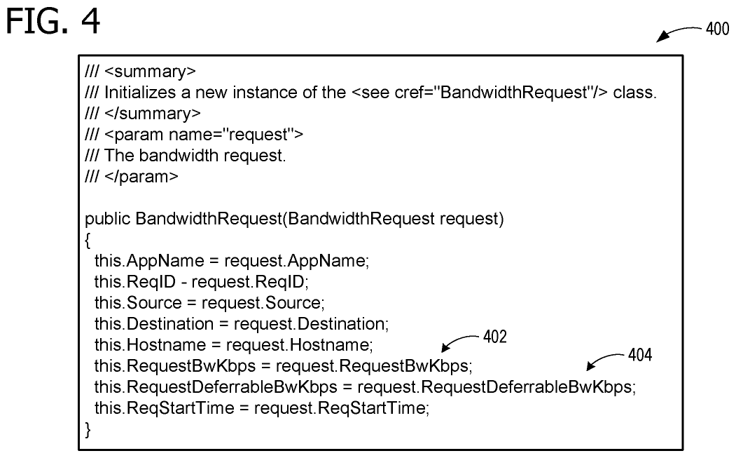

FIG. 4 illustrates an example code passage 400 associated with a bandwidth request, such as bandwidth request 210 of FIG. 2. Primary bandwidth request portion 212 and deferrable bandwidth request portion 214 are made using variable 402, shown as “RequestBWKbps”, and variable 404, shown as “RequestDeferrableBWKbps”, respectively. In the illustrated code, variables 402 and 404 are manifest as pointers.

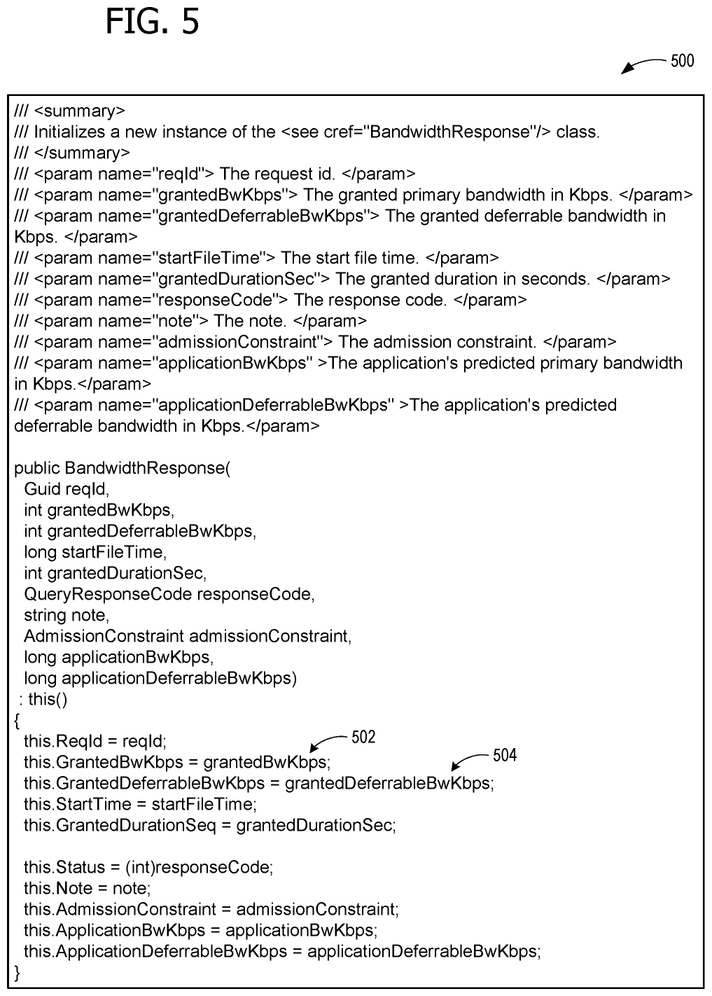

FIG. 5 illustrates an example code passage 500 associated with a response to a bandwidth request, such as indication 220 of FIG. 2 Granted primary bandwidth 222 and granted deferrable bandwidth 224 are returned using variable 502, shown as “grantedBWKbps”, and variable 504, shown as “grantedDeferrableBWKbps”, respectively. In the illustrated code, variables 502 and 504 are manifest as pointers.

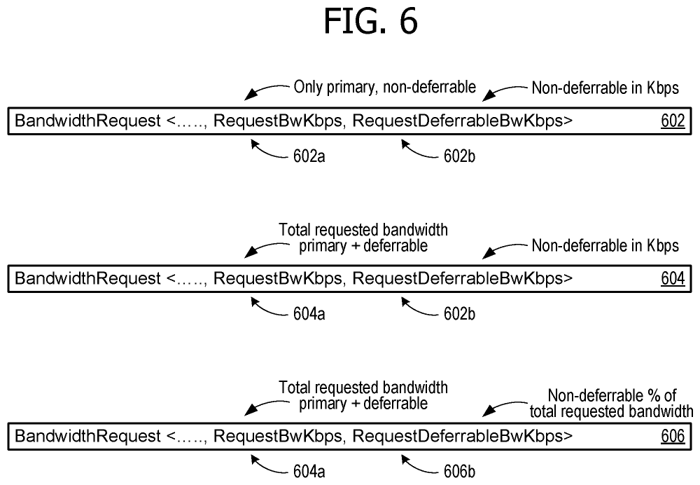

FIG. 6 illustrates example variations in the formatting of a bifurcated priority bandwidth request. Format 602 shows primary bandwidth request portion 212 as a value 602a that is only the primary, non-deferrable bandwidth request, in kilobytes per second (Kbps), and deferrable bandwidth request portion 214 as a separate value 602b, also in Kbps. In format 602, primary bandwidth request portion 212 and deferrable bandwidth request portion 214 are separate and not combined.

Format 604 shows a value 604a that is the sum of primary bandwidth request portion 212 and deferrable bandwidth request portion 214. Value 602b is only deferrable bandwidth request portion 214, and admission controller 132 (or broker backend 130) determines primary bandwidth request portion 212 by subtracting deferrable bandwidth request portion 214 from value 604a.

Format 606 also uses value 604a as the sum of primary bandwidth request portion 212 and deferrable bandwidth request portion 214, but deferrable bandwidth request portion 214 is indicated by value 606b as a percentage of value 604a. That is, deferrable bandwidth request portion 214 may be determined by multiplying value 604a by value 606b and dividing by 100. Primary bandwidth request portion 212 is then determined by subtracting deferrable bandwidth request portion 214 from value 604a. Any of formats 602-606, or other formats for conveying primary bandwidth request portion 212 and deferrable bandwidth request portion 214 may be used in architecture 100.

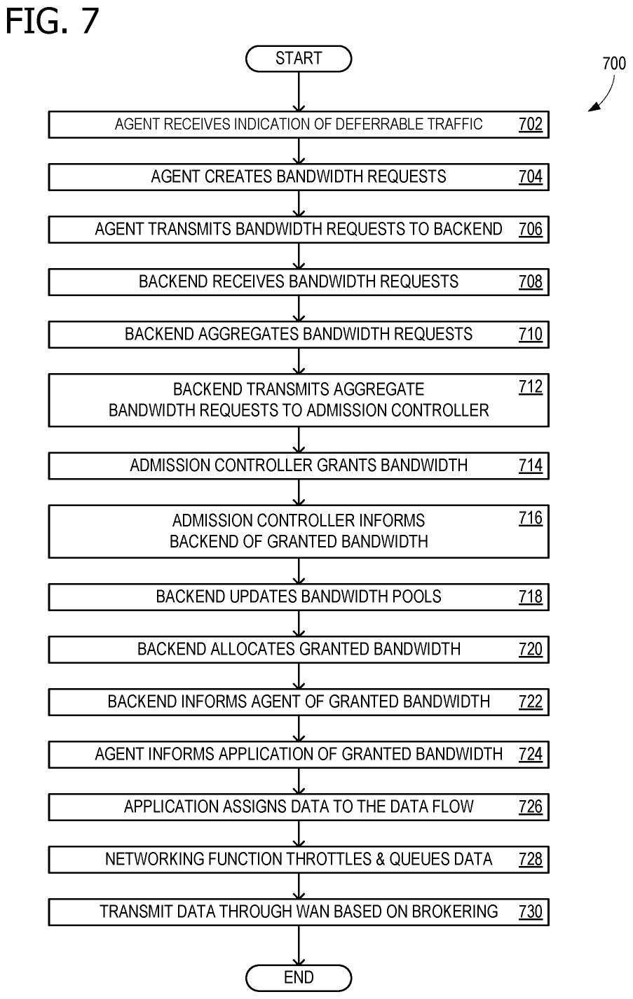

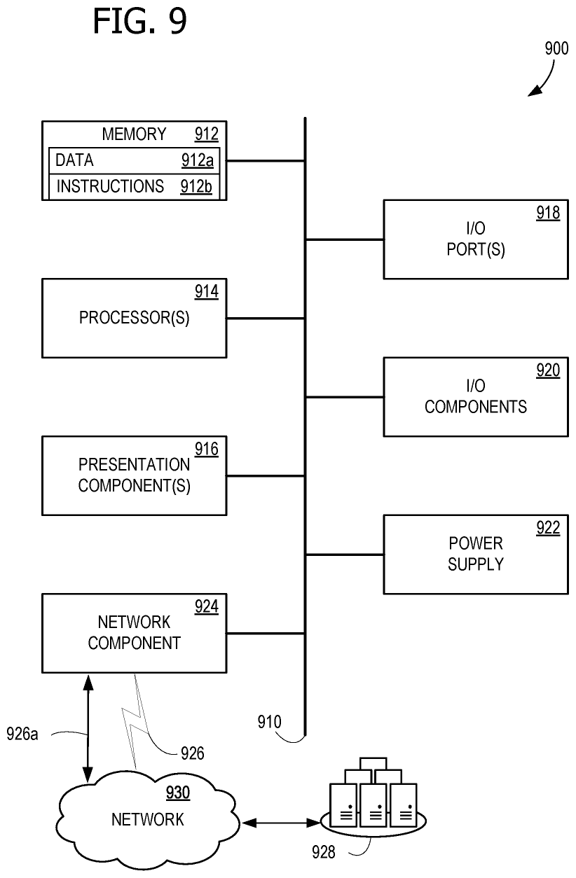

FIG. 7 shows a flowchart 700 illustrating exemplary operations that may be performed by architecture 100. In some examples, operations described for flowchart 700 are performed by computing device 900 of FIG. 9. Flowchart 700 commences with broker agent 112 receiving indication 202 of deferrable traffic for data flow 104a of plurality of data flows 104 from application 114, in operation 702.

In operation 704, broker agent 112 creates bandwidth requests for plurality of data flows 104, including creating bandwidth request 210, based on at least indication 202 of deferrable traffic. Broker agent 112 transmits the bandwidth requests for plurality of data flows 104 to broker backend 130 in operation 706, and broker backend 130 receives the bandwidth requests for plurality of data flows 104 (including bandwidth request 210 for data flow 104a) in operation 708. Each bandwidth request indicates primary bandwidth request portion 212 and the deferrable bandwidth request portion;

Broker backend 130 aggregates the bandwidth requests for plurality of data flows 104 into aggregate bandwidth request 240 in operation 710. Aggregate bandwidth request 240 indicates primary aggregate bandwidth request portion 242 and deferrable aggregate bandwidth request portion 244. In operation 712 broker backend 130 transmits aggregate bandwidth request 240 to admission controller 132.

Admission controller 132 determines granted primary aggregate bandwidth 252 and granted deferrable aggregate bandwidth 254 in operation 714, based on at least aggregate bandwidth request 240. In operation 716 admission controller 132 transmits indication 250 of granted primary aggregate bandwidth 252 and granted deferrable aggregate bandwidth 254 to broker backend 130.

Operation 718 is ongoing (i.e., across time periods for different bandwidth requests and grants), in which broker backend 130 maintains a first pool, primary bandwidth pool 232, for granted primary bandwidth 222, and a second pool, deferrable bandwidth pool 234, for granted deferrable bandwidth 224. As part of operation 718, broker backend 130 adds granted primary aggregate bandwidth 252 to the proper time period of primary bandwidth pool 232, and adds granted deferrable aggregate bandwidth 254 to the proper time period of deferrable bandwidth pool 234. Then, in operation 720, broker backend 130 allocates granted primary bandwidth and granted deferrable bandwidth for each bandwidth request for plurality of data flows 104. This includes allocating granted primary bandwidth 222 from primary bandwidth pool 232 and allocating granted deferrable bandwidth 224 from deferrable bandwidth pool 234, based on at least granted primary aggregate bandwidth 252 and granted deferrable aggregate bandwidth 254, respectively.

In operation 722 broker backend 130 transmits indication 220 of granted primary bandwidth 222 and granted deferrable bandwidth 224 to broker agent 112. In operation 724, broker agent 112 transmits indication 204 of granted total bandwidth 206 for data flow 104a to application 114. Application 114 assigns granted total bandwidth 206 for data flow 104a (e.g., in networking function 116) in operation 726.

Networking function 116 performs throttling of data from data source 302 based on at least granted total bandwidth 206 for data flow 104a, in operation 728. Data (e.g., primary data 304 and deferrable data 306) is transmitted through WAN 102, specifically through brokered data flow 104a, based on at least the allocated primary bandwidth and the allocated deferrable bandwidth for each bandwidth request for plurality of data flows 104, in operation 730.

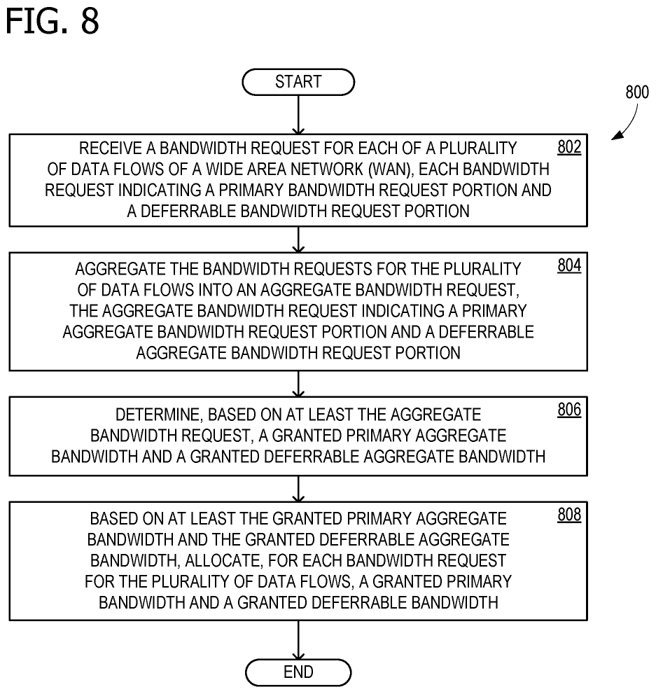

FIG. 8 shows a flowchart 800 illustrating exemplary operations that may be performed by architecture 100. In some examples, operations described for flowchart 800 are performed by computing device 900 of FIG. 9. Flowchart 800 commences with operation 802, which includes receiving a bandwidth request for each of a plurality of data flows of a WAN, each bandwidth request indicating a primary bandwidth request portion and a deferrable bandwidth request portion.

Operation 804 includes aggregating the bandwidth requests for the plurality of data flows into an aggregate bandwidth request, the aggregate bandwidth request indicating a primary aggregate bandwidth request portion and a deferrable aggregate bandwidth request portion. Operation 806 includes determining, based on at least the aggregate bandwidth request, a granted primary aggregate bandwidth and a granted deferrable aggregate bandwidth. Operation 808 includes, based on at least the granted primary aggregate bandwidth and the granted deferrable aggregate bandwidth, allocating, for each bandwidth request for the plurality of data flows, a granted primary bandwidth and a granted deferrable bandwidth.

### Additional Examples

An example system comprises: a processor; and a computer-readable medium storing instructions that are operative upon execution by the processor to: receive a bandwidth request for each of a plurality of data flows of a WAN, each bandwidth request indicating a primary bandwidth request portion and a deferrable bandwidth request portion; aggregate the bandwidth requests for the plurality of data flows into an aggregate bandwidth request, the aggregate bandwidth request indicating a primary aggregate bandwidth request portion and a deferrable aggregate bandwidth request portion; determine, based on at least the aggregate bandwidth request, a granted primary aggregate bandwidth and a granted deferrable aggregate bandwidth; and based on at least the granted primary aggregate bandwidth and the granted deferrable aggregate bandwidth, allocate, for each bandwidth request for the plurality of data flows, a granted primary bandwidth and a granted deferrable bandwidth.

An example computer-implemented method comprises: receiving a bandwidth request for each of a plurality of data flows of a WAN, each bandwidth request indicating a primary bandwidth request portion and a deferrable bandwidth request portion; aggregating the bandwidth requests for the plurality of data flows into an aggregate bandwidth request, the aggregate bandwidth request indicating a primary aggregate bandwidth request portion and a deferrable aggregate bandwidth request portion; determining, based on at least the aggregate bandwidth request, a granted primary aggregate bandwidth and a granted deferrable aggregate bandwidth; and based on at least the granted primary aggregate bandwidth and the granted deferrable aggregate bandwidth, allocating, for each bandwidth request for the plurality of data flows, a granted primary bandwidth and a granted deferrable bandwidth.

One or more example computer storage devices have computer-executable instructions stored thereon, which, on execution by a computer, cause the computer to perform operations comprising: receiving a bandwidth request for each of a plurality of data flows of a WAN, each bandwidth request indicating a primary bandwidth request portion and a deferrable bandwidth request portion; aggregating the bandwidth requests for the plurality of data flows into an aggregate bandwidth request, the aggregate bandwidth request indicating a primary aggregate bandwidth request portion and a deferrable aggregate bandwidth request portion; determining, based on at least the aggregate bandwidth request, a granted primary aggregate bandwidth and a granted deferrable aggregate bandwidth; and based on at least the granted primary aggregate bandwidth and the granted deferrable aggregate bandwidth, allocating, for each bandwidth request for the plurality of data flows, a granted primary bandwidth and a granted deferrable bandwidth.

Alternatively, or in addition to the other examples described herein, examples include any combination of the following:
based on at least the granted primary bandwidth and the granted deferrable bandwidth for each bandwidth request for the plurality of data flows, transmitting data through the WAN;
a broker backend receives, from a broker agent, the bandwidth requests for the plurality of data flows;
the broker backend aggregates the bandwidth requests for the plurality of data flows into the aggregate bandwidth request;
the broker backend allocates the granted primary bandwidth and the granted deferrable bandwidth;
an admission controller determines the granted primary aggregate bandwidth and the granted deferrable aggregate bandwidth;
transmitting, by the broker agent, to the broker backend, the bandwidth requests for the plurality of data flows;
transmitting, by the broker backend, to the admission controller, the aggregate bandwidth request;
transmitting, by the admission controller, to the broker backend, an indication of the granted primary aggregate bandwidth and the granted deferrable aggregate bandwidth;
transmitting, by the broker backend, to the broker agent, an indication of the granted primary bandwidth and the granted deferrable bandwidth;
receiving, by the broker agent, from an application, an indication of deferrable traffic for a first data flow of the plurality of data flows; based on at least the indication of deferrable traffic, creating, by the broker agent, the bandwidth requests for the plurality of data flows;
transmitting, by the broker agent, to the application, an indication of a granted total bandwidth for the first data flow, the granted total bandwidth for the first data flow including, for the first flow, a sum of the granted primary bandwidth and the granted deferrable bandwidth;
assigning, by the application, to the first data flow, the granted total bandwidth for the first data flow;
maintaining, by the broker backend, a first pool for the granted primary bandwidth and a second pool for the granted deferrable bandwidth;
allocating the granted primary bandwidth comprises allocating the granted primary bandwidth from the first pool;
allocating the granted deferrable bandwidth comprises allocating the granted primary bandwidth from the second pool;
each of the bandwidth requests, each of the granted primary bandwidths, and each of the granted deferrable bandwidths is for a specific time period;
each bandwidth request indicates its primary bandwidth request portion and its deferrable bandwidth request separately;
each bandwidth request indicates, for each data flow, the total requested bandwidth and the deferrable bandwidth request portion as a portion of the total requested bandwidth;
the total requested bandwidth comprises a sum of the primary bandwidth request portion and the deferrable bandwidth request portion;
the deferrable bandwidth request portion is expressed as a bandwidth amount;
the deferrable bandwidth request portion is expressed as a percentage;
a networking function performs throttling of data from a data source based on at least the granted total bandwidth for the first data flow;
the application performs queuing of data for the first data flow; and
the bandwidth requests are based on at least a history of the plurality of data flows.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 9 is a block diagram of an example computing device 900 (e.g., a computer storage device) for implementing aspects disclosed herein, and is designated generally as computing device 900. In some examples, one or more computing devices 900 are provided for an on-premises computing solution. In some examples, one or more computing devices 900 are provided as a cloud computing solution. In some examples, a combination of on-premises and cloud computing solutions are used. Computing device 900 is but one example of a suitable computing environment and is not intended to suggest any limitation as to the scope of use or functionality of the examples disclosed herein, whether used singly or as part of a larger set.

Neither should computing device 900 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 900 includes a bus 910 that directly or indirectly couples the following devices: computer storage memory 912, one or more processors 914, one or more presentation components 916, input/output (I/O) ports 918, I/O components 920, a power supply 922, and a network component 924. While computing device 900 is depicted as a seemingly single device, multiple computing devices 900 may work together and share the depicted device resources. For example, memory 912 may be distributed across multiple devices, and processor(s) 914 may be housed with different devices.

Bus 910 represents what may be one or more busses (such as an address bus, data bus, or a combination thereof). Although the various blocks of FIG. 9 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 9 and the references herein to a “computing device.” Memory 912 may take the form of the computer storage media referenced below and operatively provide storage of computer-readable instructions, data structures, program modules and other data for the computing device 900. In some examples, memory 912 stores one or more of an operating system, a universal application platform, or other program modules and program data. Memory 912 is thus able to store and access data 912a and instructions 912b that are executable by processor 914 and configured to carry out the various operations disclosed herein.

In some examples, memory 912 includes computer storage media. Memory 912 may include any quantity of memory associated with or accessible by the computing device 900. Memory 912 may be internal to the computing device 900 (as shown in FIG. 9), external to the computing device 900 (not shown), or both (not shown). Additionally, or alternatively, the memory 912 may be distributed across multiple computing devices 900, for example, in a virtualized environment in which instruction processing is carried out on multiple computing devices 900. For the purposes of this disclosure, “computer storage media,” “computer storage memory,” “memory,” and “memory devices” are synonymous terms for the memory 912, and none of these terms include carrier waves or propagating signaling.

Processor(s) 914 may include any quantity of processing units that read data from various entities, such as memory 912 or I/O components 920. Specifically, processor(s) 914 are programmed to execute computer-executable instructions for implementing aspects of the disclosure. The instructions may be performed by the processor, by multiple processors within the computing device 900, or by a processor external to the client computing device 900. In some examples, the processor(s) 914 are programmed to execute instructions such as those illustrated in the flow charts discussed below and depicted in the accompanying drawings. Moreover, in some examples, the processor(s) 914 represent an implementation of analog techniques to perform the operations described herein. For example, the operations may be performed by an analog client computing device 900 and/or a digital client computing device 900. Presentation component(s) 916 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 900, across a wired connection, or in other ways. I/O ports 918 allow computing device 900 to be logically coupled to other devices including I/O components 920, some of which may be built in. Example I/O components 920 include, for example but without limitation, a microphone, joystick, game pad, satellite dish, scanner, printer, wireless device, etc.

Computing device 900 may operate in a networked environment via the network component 924 using logical connections to one or more remote computers. In some examples, the network component 924 includes a network interface card and/or computer-executable instructions (e.g., a driver) for operating the network interface card. Communication between the computing device 900 and other devices may occur using any protocol or mechanism over any wired or wireless connection. In some examples, network component 924 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 924 communicates over wireless communication link 926 and/or a wired communication link 926a to a remote resource 928 (e.g., a cloud resource) across network 930. Various different examples of communication links 926 and 926a include a wireless connection, a wired connection, and/or a dedicated link, and in some examples, at least a portion is routed through the internet.

Although described in connection with an example computing device 900, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
receive a bandwidth request for each of a plurality of data flows of a wide area network (WAN), each bandwidth request indicating a primary bandwidth request portion and a deferrable bandwidth request portion;
aggregate the bandwidth requests for the plurality of data flows into an aggregate bandwidth request, the aggregate bandwidth request indicating a primary aggregate bandwidth request portion and a deferrable aggregate bandwidth request portion;
determine, based on at least the aggregate bandwidth request, a granted primary aggregate bandwidth and a granted deferrable aggregate bandwidth; and
based on at least the granted primary aggregate bandwidth and the granted deferrable aggregate bandwidth, allocate, for each bandwidth request for the plurality of data flows, a granted primary bandwidth and a granted deferrable bandwidth.

2. The system of claim 1, wherein the instructions are further operative to:
based on at least the granted primary bandwidth and the granted deferrable bandwidth for each bandwidth request for the plurality of data flows, transmit data through the WAN.

3. The system of claim 1,
wherein a broker backend receives, from a broker agent, the bandwidth requests for the plurality of data flows;
wherein the broker backend aggregates the bandwidth requests for the plurality of data flows into the aggregate bandwidth request;
wherein the broker backend allocates the granted primary bandwidth and the granted deferrable bandwidth;
wherein an admission controller determines the granted primary aggregate bandwidth and the granted deferrable aggregate bandwidth; and
wherein the instructions are further operative to:
transmit, by the broker agent, to the broker backend, the bandwidth requests for the plurality of data flows;
transmit, by the broker backend, to the admission controller, the aggregate bandwidth request;
transmit, by the admission controller, to the broker backend, an indication of the granted primary aggregate bandwidth and the granted deferrable aggregate bandwidth; and
transmit, by the broker backend, to the broker agent, an indication of the granted primary bandwidth and the granted deferrable bandwidth.

4. The system of claim 3, wherein the instructions are further operative to:
receive, by the broker agent, from an application, an indication of deferrable traffic for a first data flow of the plurality of data flows;
based on at least the indication of deferrable traffic, create, by the broker agent, the bandwidth requests for the plurality of data flows;
transmit, by the broker agent, to the application, an indication of a granted total bandwidth for the first data flow, the granted total bandwidth for the first data flow including, for the first data flow, a sum of the granted primary bandwidth and the granted deferrable bandwidth; and
assign, by the application, to the first data flow, the granted total bandwidth for the first data flow.

5. The system of claim 3, wherein the instructions are further operative to:
maintain, by the broker backend, a first pool for the granted primary bandwidth and a second pool for the granted deferrable bandwidth;
wherein allocating the granted primary bandwidth comprises allocating the granted primary bandwidth from the first pool; and
wherein allocating the granted deferrable bandwidth comprises allocating the granted deferrable bandwidth from the second pool.

6. The system of claim 1, wherein each of the bandwidth requests, each of the granted primary bandwidths, and each of the granted deferrable bandwidths is for a specific time period.

7. The system of claim 1, wherein each bandwidth request indicates its primary bandwidth request portion and its deferrable bandwidth request portion separately.

8. A computer-implemented method comprising:
receiving a bandwidth request for each of a plurality of data flows of a wide area network (WAN), each bandwidth request indicating a primary bandwidth request portion and a deferrable bandwidth request portion;
aggregating the bandwidth requests for the plurality of data flows into an aggregate bandwidth request, the aggregate bandwidth request indicating a primary aggregate bandwidth request portion and a deferrable aggregate bandwidth request portion;
determining, based on at least the aggregate bandwidth request, a granted primary aggregate bandwidth and a granted deferrable aggregate bandwidth; and
based on at least the granted primary aggregate bandwidth and the granted deferrable aggregate bandwidth, allocating, for each bandwidth request for the plurality of data flows, a granted primary bandwidth and a granted deferrable bandwidth.

9. The computer-implemented method of claim 8, further comprising:
based on at least the granted primary bandwidth and the granted deferrable bandwidth for each bandwidth request for the plurality of data flows, transmitting data through the WAN.

10. The computer-implemented method of claim 8,
wherein a broker backend receives, from a broker agent, the bandwidth requests for the plurality of data flows;
wherein the broker backend aggregates the bandwidth requests for the plurality of data flows into the aggregate bandwidth request;
wherein the broker backend allocates the granted primary bandwidth and the granted deferrable bandwidth;
wherein an admission controller determines the granted primary aggregate bandwidth and the granted deferrable aggregate bandwidth; and
wherein the method further comprises:
transmitting, by the broker agent, to the broker backend, the bandwidth requests for the plurality of data flows;
transmitting, by the broker backend, to the admission controller, the aggregate bandwidth request;
transmitting, by the admission controller, to the broker backend, an indication of the granted primary aggregate bandwidth and the granted deferrable aggregate bandwidth; and
transmitting, by the broker backend, to the broker agent, an indication of the granted primary bandwidth and the granted deferrable bandwidth.

11. The computer-implemented method of claim 10, further comprising:
receiving, by the broker agent, from an application, an indication of deferrable traffic for a first data flow of the plurality of data flows;
based on at least the indication of deferrable traffic, creating, by the broker agent, the bandwidth requests for the plurality of data flows;
transmitting, by the broker agent, to the application, an indication of a granted total bandwidth for the first data flow, the granted total bandwidth for the first data flow including, for the first data flow, a sum of the granted primary bandwidth and the granted deferrable bandwidth; and
assigning, by the application, to the first data flow, the granted total bandwidth for the first data flow.

12. The computer-implemented method of claim 10, further comprising:
maintaining, by the broker backend, a first pool for the granted primary bandwidth and a second pool for the granted deferrable bandwidth;
wherein allocating the granted primary bandwidth comprises allocating the granted primary bandwidth from the first pool; and
wherein allocating the granted deferrable bandwidth comprises allocating the granted deferrable bandwidth from the second pool.

13. The computer-implemented method of claim 8, wherein each of the bandwidth requests, each of the granted primary bandwidths, and each of the granted deferrable bandwidths is for a specific time period.

14. The computer-implemented method of claim 8, wherein each bandwidth request indicates its primary bandwidth request portion and its deferrable bandwidth request portion separately.

15. A computer storage device having computer-executable instructions stored thereon, which, on execution by a computer, cause the computer to perform operations comprising:
receiving a bandwidth request for each of a plurality of data flows of a wide area network (WAN), each bandwidth request indicating a primary bandwidth request portion and a deferrable bandwidth request portion;
aggregating the bandwidth requests for the plurality of data flows into an aggregate bandwidth request, the aggregate bandwidth request indicating a primary aggregate bandwidth request portion and a deferrable aggregate bandwidth request portion;
determining, based on at least the aggregate bandwidth request, a granted primary aggregate bandwidth and a granted deferrable aggregate bandwidth; and
based on at least the granted primary aggregate bandwidth and the granted deferrable aggregate bandwidth, allocating, for each bandwidth request for the plurality of data flows, a granted primary bandwidth and a granted deferrable bandwidth.

16. The computer storage device of claim 15, wherein the operations further comprise:
based on at least the granted primary bandwidth and the granted deferrable bandwidth for each bandwidth request for the plurality of data flows, transmitting data through the WAN.

17. The computer storage device of claim 15,
wherein a broker backend receives, from a broker agent, the bandwidth requests for the plurality of data flows;
wherein the broker backend aggregates the bandwidth requests for the plurality of data flows into the aggregate bandwidth request;
wherein the broker backend allocates the granted primary bandwidth and the granted deferrable bandwidth;
wherein an admission controller determines the granted primary aggregate bandwidth and the granted deferrable aggregate bandwidth; and
wherein the operations further comprise:
transmitting, by the broker agent, to the broker backend, the bandwidth requests for the plurality of data flows;
transmitting, by the broker backend, to the admission controller, the aggregate bandwidth request;
transmitting, by the admission controller, to the broker backend, an indication of the granted primary aggregate bandwidth and the granted deferrable aggregate bandwidth; and
transmitting, by the broker backend, to the broker agent, an indication of the granted primary bandwidth and the granted deferrable bandwidth.

18. The computer storage device of claim 17, wherein the operations further comprise:
receiving, by the broker agent, from an application, an indication of deferrable traffic for a first data flow of the plurality of data flows;
based on at least the indication of deferrable traffic, creating, by the broker agent, the bandwidth requests for the plurality of data flows;
transmitting, by the broker agent, to the application, an indication of a granted total bandwidth for the first data flow, the granted total bandwidth for the first data flow including, for the first data flow, a sum of the granted primary bandwidth and the granted deferrable bandwidth; and
assigning, by the application, to the first data flow, the granted total bandwidth for the first data flow.

19. The computer storage device of claim 17, wherein the operations further comprise:
maintaining, by the broker backend, a first pool for the granted primary bandwidth and a second pool for the granted deferrable bandwidth;
wherein allocating the granted primary bandwidth comprises allocating the granted primary bandwidth from the first pool; and
wherein allocating the granted deferrable bandwidth comprises allocating the granted deferrable bandwidth from the second pool.

20. The computer storage device of claim 15, wherein each of the bandwidth requests, each of the granted primary bandwidths, and each of the granted deferrable bandwidths is for a specific time period.
